(19) United States
(12) Patent Application Publication
(10) Pub. No.: US 2008/0218527 A1
(43) Pub. Date: Sep. 11, 2008

(54) Method and Apparatus for Improving Hit Rates of a Cache Memory for Storing Texture Data During Graphics Rendering

(76) Inventor: Ian D. Romanick, Portland, OR (US)

Correspondence Address: DILLON & YUDELL, LLP, 8911 N CAPITAL OF TEXAS HWY, SUITE 2110, AUSTIN, TX, 78759, US

(21) Appl. No.: 11/684,066

(22) Filed: Mar. 9, 2007

(51) Int. Cl. G09G 5/39

(52) U.S. Cl. 345/587; 345/552

(57) ABSTRACT

A method for improving hit rates of a cache memory for storing texture data during graphics rendering is disclosed. In response to a request for a mipmap block from a first mipmap to render a texture, a determination is made whether or not the mipmap block from the first mipmap is already stored in a cache memory. If the mipmap block from the first mipmap is already in the cache memory, the mipmap block from the first mipmap already in the cache memory is utilized to render the texture. Otherwise, if the mipmap block from the first mipmap is not in a cache memory, another determination is made whether or not a bias value associated with the mipmap block from the first mipmap is set. If a bias value associated with the mipmap block from the first mipmap is not set, then the mipmap block is obtained from the first mipmap to render the texture.

### BACKGROUND OF THE INVENTION

1. Technical Field

The present invention relates to graphics rendering in general, and more particularly, to a method and apparatus for improving the speed of graphics rendering. Still more particularly, the present invention relates to a method and apparatus for improving hit rates of a cache memory for storing texture data during graphics rendering.

2. Description of Related Art

Graphics rendering is commonly performed on graphical models in order produce realistic three-dimensional (3D) graphical objects for a graphic intensive software application. Graphics rendering may include, for example, texture mapping to apply surface texture, color and shape to surfaces of 3D graphical objects.

Texture mapping on graphical objects are generated by successive averaging of texture data or through the use of signal analysis such as Fourier transforms. Graphics rendering chips are commonly utilized to performing texture mapping, and most graphics rendering chips include on-chip cache memory for storing recently accessed texture data for future use. Graphics with high-resolution textures require more texture data, which decreases coherency and increases aliasing in the on-chip cache memory. On the other hand, graphics with low-resolution textures have less demand on the on-chip cache memory, but the texture quality of rendered images may not be acceptable.

Consequently, it would be desirable to provide a method and apparatus for improving the hit rate of the on-chip cache memory without adversely impacting the texture quality of the rendered images.

### SUMMARY OF THE INVENTION

In accordance with a preferred embodiment of the present invention, in response to a request for a mipmap block from a first mipmap to render a texture, a determination is made whether or not the mipmap block from the first mipmap is already stored in a cache memory. If the mipmap block from the first mipmap is already in the cache memory, the mipmap block from the first mipmap already in the cache memory is utilized to render the texture. Otherwise, if the mipmap block from the first mipmap is not in a cache memory, another determination is made whether or not a bias value associated with the mipmap block from the first mipmap is set. If a bias value associated with the mipmap block from the first mipmap is not set, then the mipmap block is obtained from the first mipmap to render the texture.

However, if a bias value associated with the mipmap block from the first mipmap is set, another determination is made whether or not a smaller version of the mipmap block from a second mipmap is already stored in the cache memory. If the mipmap block from the second mipmap is already in said cache memory, the mipmap block from the second mipmap already in the cache memory is utilized to render the texture. Otherwise, if the mipmap block from the second mipmap is not in the cache memory, the mipmap block is obtained from the second mipmap to render the texture.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a data processing system in which a preferred embodiment of the present invention can be incorporated;

FIG. 2 graphically illustrates two mipmaps and corresponding bias value tables, in accordance with a preferred embodiment of the present invention; and

FIG. 3 is a high-level logic flow diagram of a method for improving hit rates of a cache memory for storing texture data during graphics rendering, in accordance with a preferred embodiment of the present invention.

### DETAILED DESCRIPTION OF A PREFERRED EMBODIMENT

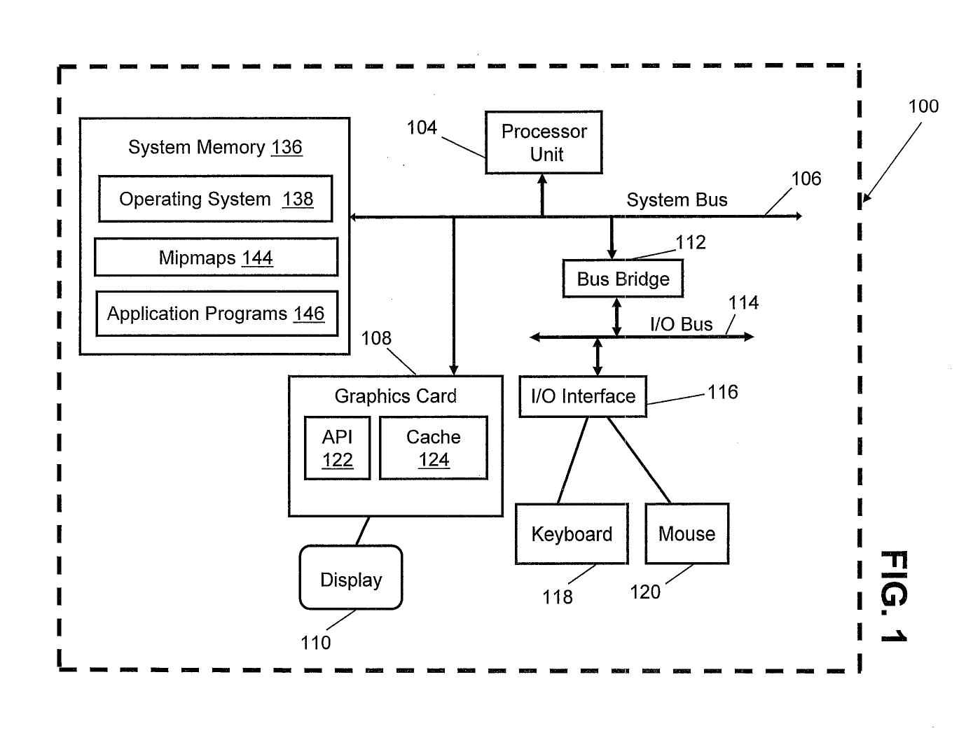

Referring now to the drawings, and specifically to FIG. 1, there is depicted a block diagram of a data processing system in which a preferred embodiment of the present invention can be incorporated. As shown, a data processing system 100 includes a processor unit 104 that is coupled to a system bus 106. System bus 106 is coupled to an input/output (I/O) bus 114 via a bus bridge 112. An I/O interface 116, which is coupled to I/O bus 114, affords communication with various I/O devices, including a keyboard 118, and a mouse 120.

A system memory 136 is also coupled to system bus 106. Code that populates system memory 136 includes an operating system (OS) 138, multiple mipmaps 144, and one or more application programs 146. Mipmaps are collections of optimized but less detailed and smaller size images that accompany a texture. Mipmaps can increase the speed of graphics rendering by reducing the amount of texture pixels (also known as textels) that must be processed. In addition, mipmaps also reduce the number of artifacts since each of the pre-calculated mipmap images is anti-aliased. A texture can be associated with multiple mipmaps of various sizes, and the size of a mipmap corresponds to the level of details (LOD) of the textels.

A graphics card 108, which controls a display 110, is also coupled to system bus 106. Graphics card 108 utilizes mipmaps 144 to generate images on display 110. Graphics card 108 includes an application programming interface (API) 122 and a cache memory 124. Cache memory 124 provides local storage for recently accessed texture data.

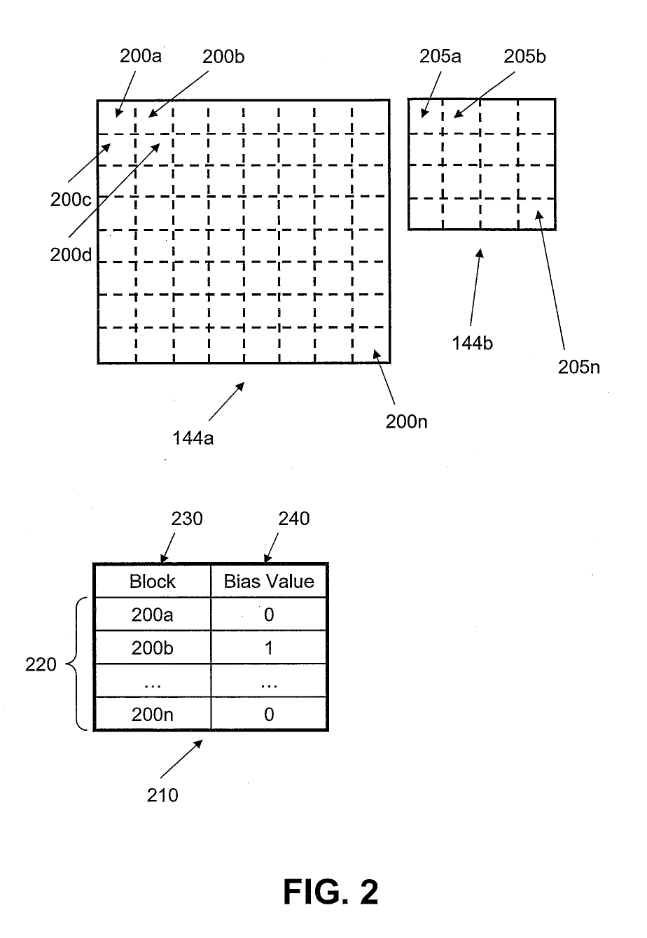

With reference now to FIG. 2, there are graphically illustrated two mipmaps, in accordance with a preferred embodiment of the present invention. As shown, a mipmap 144a is divided into mipmap blocks 200a-200n, and a mipmap 144b is divided into mipmap blocks 205a-205n. The division of mipmaps 144a and 144b into various corresponding mipmap blocks may be performed by an API (such as API 122 from FIG. 1), and an even number of mipmap blocks is desired. Both mipmaps 144a and 144b are associated with a specific image, but mipmap 144a provides higher LOD of texels than mipmap 144b. Each of mipmap blocks 205a-205n in mipmap 144b corresponds to four mipmap blocks in mipmap 144a. For example, mipmap block 205a in mipmap 144b corresponds to mipmap blocks 200a-200d in mipmap 144a, and mipmap block 205b in mipmap 144b corresponds to four mipmap blocks adjacent to mipmap blocks 200a-200d in mipmap 144a.

A signal analysis technique, such as a Fourier transform, can be performed on each of mipmap blocks 200a-200n within mipmap 144a, and a bias value is assigned to each of mipmap blocks 200a-200n based on a pre-defined frequency threshold. If a mipmap block corresponds to a portion of the mipmap that includes most data values below the pre-defined frequency threshold (i.e., low-frequency data), then the corresponding bias value for that mipmap block is assigned to a logical “1.” Otherwise, if a mipmap block corresponds to a portion of the mipmap that includes most data values above the pre-defined frequency threshold (i.e., high-frequency data), then the corresponding bias value for that mipmap block is assigned to a logical “0.” For the present embodiment, signal analysis needs to be performed on the mipmap blocks of the largest mipmap only.

All the assigned bias values are then recorded in a bias value table. For example, as illustrated in FIG. 2, the bias values from mipmap 144a are stored in a bias value table 210. Bias value table 210 includes entries 220, and each of entries 220 has a mipmap block field 230 and a bias value field 240. Each of entries 220 corresponds to one of mipmap blocks 200a-200n within mipmap 144a.

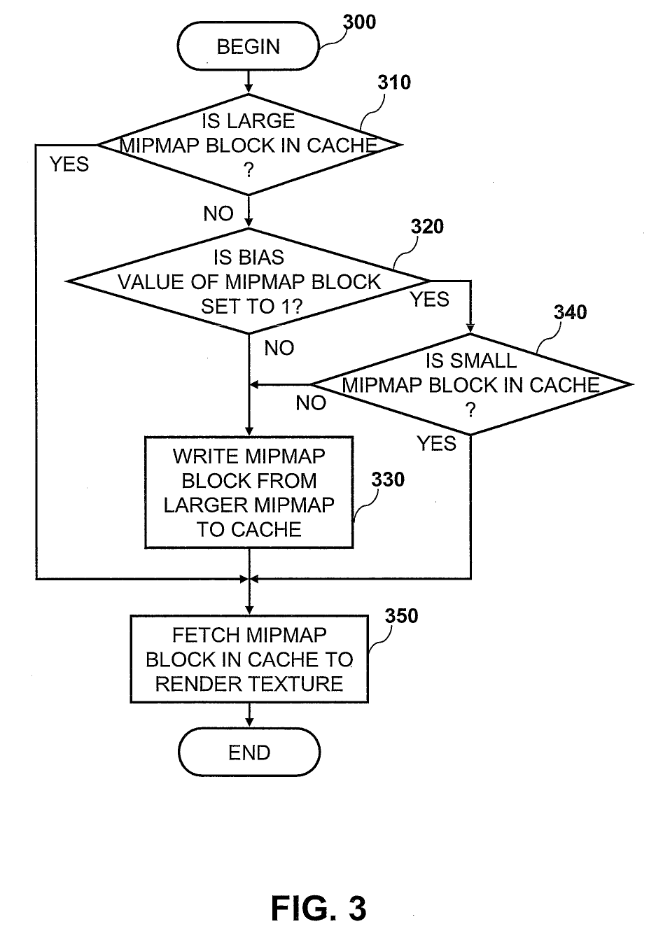

Referring now to FIG. 3, there is depicted a high-level logic flow diagram of a method for improving hit rates of a cache memory (such as cache memory 124 from FIG. 1) for storing texture data during graphics rendering, in accordance with a preferred embodiment of the present invention. Starting at block 300, in response to a request for a mipmap block from a first mipmap (such as mipmap 144a from FIG. 2) to render a texture, a determination is made whether or not the mipmap block is stored in a cache memory (such as cache memory 124 from FIG. 1), as shown in block 310. If the mipmap block is stored in the cache memory, the mipmap block from the cache memory is utilized to render the texture, as depicted in block 350. Otherwise, if the mipmap block is not stored in the cache memory, a determination is made within a bias value table (such as bias value table 210 from FIG. 2) whether or not the bias value for the mipmap block is set to a logical “1,” as depicted in block 320. If the bias value for the mipmap block is not set to a logical “1,” the mipmap block from the first mipmap is written into the cache memory, as shown in block 330, and the mipmap block from the cache memory is utilized to render the texture, as depicted in block 350.

However, if the bias value for the mipmap block is set to a logical “1,” a determination is made whether or not a similar mipmap block from a second (smaller but related) mipmap (such as mipmap 144b from FIG. 2) is already stored in the cache memory, as shown in block 340. If the similar mipmap block is already stored in the cache memory, the mipmap block from the cache memory is utilized to render the texture, as depicted in block 350. Otherwise, if the similar mipmap block is not stored in the cache memory, the mipmap block from the second mipmap is written into the cache memory, as shown in block 330, and the mipmap block from the cache memory is utilized to render the texture, as depicted in block 350.

As has been described, the present invention provides a method and apparatus for improving hit rates of a cache memory for storing texture data during graphics rendering. The present invention enables different level of detail bias values to be assigned to different regions of the source texture of a mipmap. A smaller amount of data can be stored in a cache memory for portions of the mipmap that only require relatively low image quality without adversely affecting portions of the mipmap that require greater image quality.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for improving hit rates of a cache memory for storing texture data during graphics rendering, said method comprising:
in response to a request for a mipmap block from a first mipmap to render a texture, determining whether or not said mipmap block from said first mipmap is already stored in a cache memory;
in a determination that said mipmap block from said first mipmap is already stored in a cache memory, utilizing said mipmap block from said first mipmap already stored in said cache memory to render said texture;
in a determination that said mipmap block from said first mipmap is not stored in a cache memory, determining whether or not a bias value associated with said mipmap block from said first mipmap is set;
in a determination that a bias value associated with said mipmap block from said first mipmap is not set, obtaining said mipmap block from said first mipmap to render said texture;
in a determination that a bias value associated with said mipmap block from said first mipmap is set, determining whether or not a smaller version of said mipmap block from a second mipmap is already stored in said cache memory;
in a determination that said mipmap block from said second mipmap is already stored in said cache memory, utilizing said mipmap block from said second mipmap already stored in said cache memory to render said texture; and
in a determination that said mipmap block from said second mipmap is not stored in said cache memory, obtaining said mipmap block from said second mipmap to render said texture.

2. The method of claim 1, wherein said method further includes:
dividing said first and second mipmaps into a plurality of mipmap blocks, wherein said first mipmap is larger than said second mipmap, and both of said mipmaps are associated with said texture; and
performing a signal analysis on each of said plurality of mipmap blocks in said first mipmap to assign a bias value for each of said plurality of mipmap blocks based on whether or not a mipmap block is greater than a predetermined threshold value.

3. The method of claim 2, wherein said method further includes
setting a bias value when a mipmap block corresponds to a portion of said mipmap that includes low frequency data; and
unsetting a bias value when a mipmap block corresponds to a portion of said mipmap that includes high frequency data.

4. A computer usable medium for improving hit rates of a cache memory for storing texture data during graphics rendering, said computer usable medium comprising:
computer program code for, in response to a request for a mipmap block from a first mipmap to render a texture, determining whether or not said mipmap block from said first mipmap is already stored in a cache memory;
computer program code for, in a determination that said mipmap block from said first mipmap is already stored in a cache memory, utilizing said mipmap block from said first mipmap already stored in said cache memory to render said texture;
computer program code for, in a determination that said mipmap block from said first mipmap is not stored in a cache memory, determining whether or not a bias value associated with said mipmap block from said first mipmap is set;
computer program code for, in a determination that a bias value associated with said mipmap block from said first mipmap is not set, obtaining said mipmap block from said first mipmap to render said texture;
computer program code for, in a determination that a bias value associated with said mipmap block from said first mipmap is set, determining whether or not a smaller version of said mipmap block from a second mipmap is already stored in said cache memory;
computer program code for, in a determination that said mipmap block from said second mipmap is already stored in said cache memory, utilizing said mipmap block from said second mipmap already stored in said cache memory to render said texture; and
computer program code for, in a determination that said mipmap block from said second mipmap is not stored in said cache memory, obtaining said mipmap block from said second mipmap to render said texture.

5. The computer usable medium of claim 4, wherein said computer usable medium further includes:
computer program code for dividing said first and second mipmaps into a plurality of mipmap blocks, wherein said first mipmap is larger than said second mipmap, and both of said mipmaps are associated with said texture; and
computer program code for performing a signal analysis on each of said plurality of mipmap blocks in said first mipmap to assign a bias value for each of said plurality of mipmap blocks based on whether or not a mipmap block is greater than a predetermined threshold value.

6. The computer usable medium of claim 5, wherein said computer usable medium further includes
computer program code for setting a bias value when a mipmap block corresponds to a portion of said mipmap that includes low frequency data; and
computer program code for unsetting a bias value when a mipmap block corresponds to a portion of said mipmap that includes high frequency data.
